(19) United States
(12) Patent Application Publication
(10) Pub. No.: US 2012/0177052 A1
(43) Pub. Date: Jul. 12, 2012

(54) USER-ORIENTED COMMUNICATION METHOD, ROUTE REGISTRATION METHOD AND DEVICE, AND COMMUNICATION SYSTEM

(75) Inventors: Yuhua Chen, Shanghai (CN); Bojie Li, Shanghai (CN); Wei Zhang, Shanghai (CN); Hong Li, Kista (SE); Chenghui Peng, Shanghai (CN); Jianjun Wu, Shanghai (CN)

(73) Assignee: Huawei Technologies Co., Ltd., Shenzhen (CN)

(21) Appl. No.: 13/425,008

(22) Filed: Mar. 20, 2012

Related U.S. Application Data
(63) Continuation of application No. PCT/CN2010/077180, filed on Sep. 21, 2010.

(30) Foreign Application Priority Data
Sep. 23, 2009 (CN) 200910174225.8

(51) Int. Cl. H04L 12/56

(52) U.S. Cl. 370/392; 370/401

(57) ABSTRACT

Embodiments of the present disclosure disclose a user-oriented communication method, a route registration method and device, and a communication system. In the method, a first domain router receives a first data packet sent by a first terminal. The first data packet includes a user identifier of a first user and a user identifier of a second user, the first terminal belongs to the first user, and a second terminal belongs to the second user. The first domain router queries for a second domain router connected to the second terminal according to the user identifier of the second user and sends the first data packet to the second domain router, so that the second domain router sends the first data packet to the second terminal.

### CROSS-REFERENCE TO RELATED APPLICATIONS

This application is a continuation of International Application No. PCT/CN2010/077180, filed on Sep. 21, 2010, which claims priority to Chinese Patent Application No. 200910174225.8, filed on Sep. 23, 2009, both of which are hereby incorporated by reference in their entireties.

### FIELD

The present disclosure relates to the field of communication technologies, and in particular, to a user-oriented communication method, a route registration method and device, and a communication system.

### BACKGROUND

The Internet Protocol (IP, Internet Protocol) is a communication protocol used on the Internet (Internet). At present, the IP address on a network has double semantics:

Location (Locator for short) semantic: From the perspective of network topology, the IP address that is allocated to a certain terminal (host) indicates a topological location when the terminal accesses the network. When the terminal moves, the topological location of the terminal accessing the network is also changed. Therefore, the corresponding IP address is also changed, and the IP address has the Locator semantic.

Identifier (Identifier) semantic: From the perspective of application, the IP address represents the identity of a corresponding terminal, that is, the IP address is used as an identifier through which both communication parties identify each other in the process of communication between terminals. In a state of an application connection being not disconnected, the IP address is required to remain unchanged as long as possible. The IP address has the Identifier semantic.

At the beginning of design of the Internet, the core network adopts a unicast and best-effort sending model. Moreover, at that time, it is considered terminals are generally static and IP addresses are sufficient. At that time, the simple design that the IP address has double semantics is also one of important factors to a tremendous success of the Internet nowadays.

However, with the increase of Internet users, fast development of wireless networks, and expansion of the demand of people for the communication that is everywhere, the coupling of the locator and the Identifier in the IP address results in a lot of problems. For example, it breaks a principle of minimizing the coupling between different layers in the Internet hierarchy, which is disadvantageous to independent development of each layer; the communication between terminals in different network areas is difficult to be implemented according to an IP address as an identifier of the terminal. In addition, the double semantics of the IP address do not well support mobility. That is, when the terminal moves, the location of the terminal is changed, and the IP address is also changed accordingly, but the identity of the terminal remains unchanged. At this time, a contradiction arises.

The combination of the mobile communication and the Internet has become one of the network development trends in the future. With the development of portable devices in recent years, users hope to share their daily lives with their families and friends at any time and at any place, and to easily obtain needed information and services from the Internet at the same time. The users refer to persons who participate in a communication service activity and may be a natural person or a combination of multiple persons.

The prior art puts forward a Host Identity Protocol (HIP, Host Identity Protocol). HIP is a solution for splitting the double semantics of the IP address.

The principle of HIP is as follows: A HIP layer is introduced between a Transfer Control Protocol (TCP, Transfer Control Protocol) layer and an IP layer, and a host identity (HI, Host Identity) is used to identify a user, while the IP address of the IP layer is only used for routing at the network layer, that is, the IP address reserves only the Locator semantic, while the Identifier semantic is represented by the HI of the HIP layer. A HIP-based protocol stack is as shown in FIG. 1.

In HIP, the HI is an abstract concept. In actual applications, a host identity tag (HIT, host identity tag) is used, which is obtained by performing a 128-bit Hash (Hash) on the HI.

As shown in FIG. 1, the transport layer uses <HIT, port (port)> rather than <IP add (address), port> as the identity tag of the transport layer. The HIP layer completes the conversion between the HIT and the IP address in a data packet. The network layer is shielded from the transport layer, and the change of the IP address at the network layer (for example, the change of the IP address due to mobility of a terminal) does not affect the link of the transport layer.

In HIP, a dynamic binding relationship exists between the HIT and the IP address. HIP provides a mapping mechanism between the host identity and the IP address of the terminal. That is, firstly, a new infrastructure device, that is, a rendezvous server (RVS, Rendezvous Server) is introduced, which is configured to save the binding relationship between such information as the HI, HIT, and IP address of the terminal; secondly, a new record is added to a domain name server (DNS, Domain Name Server) to save the binding relationship between the HI and HIT of the terminal and the rendezvous server corresponding to the terminal.

For example, in the process of exchanging data packets over HIP, when a terminal 1 needs to send a data packet, the terminal 1 queries the DNS server for the HI and the IP address of the rendezvous server, and sends an initial data packet to the rendezvous server; and then the rendezvous server forwards the data packet to a terminal 2; after the terminal 1 and the terminal 2 acquire the network address of each other, subsequent data packets are not forwarded through the RVS, and both the communication parties communicate with each other directly unless the address of either of the communication parties is changed. In the communication process, if the IP address of either of the communication parties is changed, for example, if the terminal 1 moves, the terminal 1 needs to notify the RVS, DNS, the terminal 2, and other interconnected communication devices of the changed address of the terminal 1.

In the process of implementing the present disclosure, the inventor finds that the HIP communication mode poorly supports the mobility of users, and the implementation of user mobility management is relatively complex. For example, the device identifier is irrelevant to the network space structure, so the query efficiency is relatively low; the DNS needs to save the mapping relationship between the HI and HIT of the terminal and the rendezvous server corresponding to the terminal, which causes a heavy processing load on a user-level DNS; when the mapping relationship is changed, the terminal needs to update the mapping relationship with the DNS, the RVS, and other interconnected communication devices, which causes a heavy processing load of the terminal.

### SUMMARY OF THE DISCLOSURE

Embodiments of the present disclosure provide a user-oriented communication method, a route registration method and device, and a communication system, which helps to enhance the support for user mobility and reduce the implementation complexity of the user mobility management.

Following are embodiments of the present disclosure:

A user-oriented communication method includes: receiving, by a first domain router, a first data packet sent by a first terminal, where the first data packet carries a user identifier of a first user and a user identifier of a second user, the first terminal belongs to the first user, and a second terminal belongs to the second user; querying for a second domain router connected to the second terminal according to the user identifier of the second user; and sending the first data packet to the second domain router, so that the second domain router sends the first data packet to the second terminal.

A user-oriented communication method includes: receiving, by a second domain router, a first data packet, where the first data packet includes a user identifier of a first user and a user identifier of a second user, and a second terminal belongs to the second user; querying for a local location identifier of the second terminal according to the user identifier of the second user; and sending the first data packet to the second terminal according to the local location identifier of the second terminal.

A user-oriented communication method includes: receiving, by a second domain router, a first data packet sent by a second terminal, where a packet header of the first data packet includes a user identifier of a first user, a user identifier of a second user, and a location identifier of a first domain router that is connected to the first terminal, the first terminal belongs to the first user, and the second terminal belongs to the second user; modifying the packet header of the first data packet, where the modified packet header of the first data packet includes the user identifier of the first user, the user identifier of the second user, the location identifier of the first domain router that is connected to the first terminal, and a location identifier of the second domain router; and sending the first data packet whose packet header is modified to the first domain router.

A route registration method includes: obtaining, by a first domain router, a device identifier of a first terminal and a user identifier of a first user, where the first terminal belongs to the first user; and sending a route registration message to a subscriber location server in a current domain, where the route registration message includes the device identifier of the first terminal, user identifier of the first user, and association information of the first domain router.

A route registration method includes: receiving, by a first subscriber location server, a first route registration message, where the first route registration message includes a device identifier of a first terminal, a user identifier of a first user, and association information of a first domain router, and the first terminal belongs to the first user; obtaining the device identifier of the first terminal, the user identifier of the first user, and a location identifier of the first domain router from the first route registration message; and saving the obtained device identifier of the first terminal, user identifier of the first user, and association information of the first domain router.

A domain router includes: a receiving module, configured to receive a first data packet sent by a first terminal, where the first data packet includes a user identifier of a first user and a user identifier of a second user, the first terminal belongs to the first user, and a second terminal belongs to the second user; a querying module, configured to query for a second domain router connected to the second terminal according to the user identifier of the second user; and a sending module, configured to send the first data packet to the second domain router, so that the second domain router sends the first data packet to the second terminal.

A domain router includes: a receiving module, configured to receive a first data packet, where the first data packet includes a user identifier of a first user and a user identifier of a second user, and a second terminal belongs to the second user; a querying module, configured to query for a local location identifier of the second terminal according to the user identifier of the second user; and a sending module, configured to send the first data packet to the second terminal according to the local location identifier of the second terminal queried by the querying module.

A domain router includes: a receiving module, configured to receive a first data packet sent by a second terminal, where a packet header of the first data packet includes a user identifier of a first user, a user identifier of a second user, and a location identifier of a first domain router that is connected to a first terminal, the first terminal belongs to the first user, and the second terminal belongs to the second user; a packet header modifying module, configured to modify the packet header of the first data packet, where the modified packet header of the first data packet includes the user identifier of the first user, the user identifier of the second user, the location identifier of the first domain router that is connected to the first terminal, and a location identifier of a second domain router; and a sending module, configured to send the first data packet whose packet header is modified by the packet header modifying module to the first domain router.

A domain router includes: an obtaining module, configured to obtain a device identifier of a first terminal and a user identifier of a first user, where the first terminal belongs to the first user; and a sending module, configured to send a route registration message to a subscriber location server in a current domain, where the route registration message includes the device identifier of the first terminal, the user identifier of the first user, and association information of a first domain router.

A subscriber location server includes: a receiving module, configured to receive a first route registration message, where the first route registration message includes a device identifier of a first terminal, a user identifier of a first user, and association information of a first domain router, and the first terminal belongs to the first user; an obtaining module, configured to obtain the device identifier of the first terminal, the user identifier of the first user, and a location identifier of the first domain router from the first route registration message received by the receiving module; and an associating and saving module, configured to save the device identifier of the first terminal, user identifier of the first user, and association information of the first domain router that are obtained by the obtaining module.

A communication system includes: a first domain router, configured to: receive a first data packet sent by a first terminal, where the first data packet includes a user identifier of a first user and a user identifier of a second user, the first terminal belongs to the first user, and a second terminal belongs to the second user; query for a second domain router that is connected to the second terminal according to the user identifier of the second user; and send the first data packet to the second domain router; the second domain router, configured to: receive the first data packet sent by the first domain router, where the first data packet includes the user identifier of the first user and the user identifier of the second user; query for a local location identifier of the second terminal according to the user identifier of the second user; and send the first data packet to the second terminal according to the local location identifier of the second terminal.

It can be seen from the above that, the solution of the embodiments of the present disclosure has the following benefits:

In the embodiments of the present disclosure, based on a user identifier model, user-oriented communication is implemented in a network; because the user identifier is relatively stable, and transmission of a data packet is based on the user identifier, the communication is reliable and convenient, which helps to enhance the support for user mobility and reduce the implementation complexity of user mobility management.

### BRIEF DESCRIPTION OF THE DRAWINGS

To illustrate the solution in the present disclosure and in the prior art more clearly, the accompanying drawings needed to be used for illustrating the embodiments of the present disclosure and the prior art are briefly introduced below. Apparently, the accompanying drawings in the following description are only some embodiments of the present disclosure, and persons of ordinary skill may further derive other drawings according to these accompanying drawings without creative efforts.

FIG. 1 is a schematic diagram of a HIP protocol stack in the prior art;

FIG. 2-a is a schematic diagram of an association among a user, a terminal, and a location identifier according to an embodiment of the present disclosure;

FIG. 2-b is a schematic diagram of an architecture for a user-oriented network according to an embodiment of the present disclosure;

FIG. 3 is a flow chart of a user-oriented communication method according to Embodiment 1 of the present disclosure;

FIG. 4-a is a schematic diagram of a protocol stack according to Embodiment 2 of the present disclosure;

FIG. 4-b is a schematic diagram of another protocol stack according to Embodiment 2 of the present disclosure;

FIG. 4-c is a flow chart of a user-oriented communication method according to Embodiment 2 of the present disclosure;

FIG. 5 is a flow chart of a route registration method according to Embodiment 3 of the present disclosure;

FIG. 6 is a flowchart of another route registration method according to Embodiment 3 of the present disclosure;

FIG. 7 is a schematic diagram of a domain router according to Embodiment 4 of the present disclosure;

FIG. 8 is a schematic diagram of a domain router according to Embodiment 5 of the present disclosure;

FIG. 9 is a schematic diagram of a domain router according to Embodiment 6 of the present disclosure;

FIG. 10 is a schematic diagram of a domain router according to Embodiment 7 of the present disclosure;

FIG. 11 is a schematic diagram of a domain router according to Embodiment 8 of the present disclosure;

FIG. 12 is a schematic diagram of a subscriber location server according to Embodiment 9 of the present disclosure;

FIG. 13 is a schematic diagram of a subscriber location server according to Embodiment 10 of the present disclosure;

FIG. 14 is a schematic diagram of a communication system according to Embodiment 11 of the present disclosure; and

FIG. 15 is a schematic diagram of a communication system according to Embodiment 12 of the present disclosure.

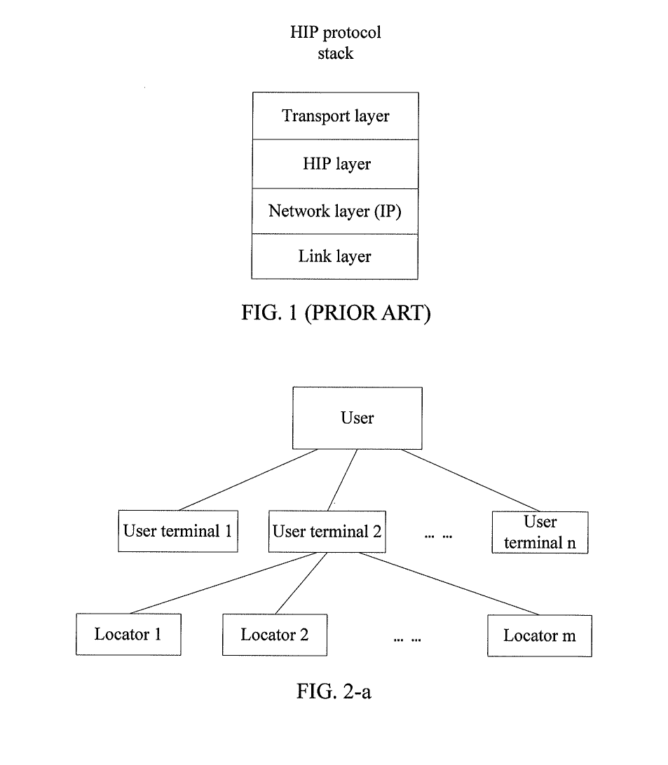

### DETAILED DESCRIPTION OF THE EMBODIMENTS

Embodiments of the present disclosure provide a user-oriented communication method, a route registration method and device, and a communication system, which helps to enhance the support for user mobility and reduce the implementation complexity of the user mobility management.

To make the above objective, feature, and merits of the present disclosure more comprehensible, the solution in the present disclosure is clearly and completely described with reference to the accompanying drawings in the following. Apparently, the embodiments are only a part rather than all of embodiments of the present disclosure. Other embodiments derived by persons of ordinary skill based on the embodiments of the present disclosure without creative efforts should fall within the protection scope of the present disclosure.

An embodiment of the present disclosure puts forward a user identifier model, where a user identifier (User ID), a device identifier (Device ID), and a location identifier (Location ID, or Locator for short) are defined.

The user ID is configured to identify a user, or a subscription (subscription) of a user. The user ID is a globally unique identifier.

The device ID is configured to identify a terminal device of a user. It may be a globally unique intra-network device identifier, for example, it may be a media access control (MAC, Media Access Control) address, an international mobile subscriber identity (IMSI, international mobile subscriber identity) or a network access identifier (NAI, Network Access Identifier). Definitely, it may also be a unique tag only in all the devices of a current user, for example, a device number, a device name, or a device type. The user terminal may be a computer, a portable computer, a mobile phone, an intelligent terminal, a vehicle-mounted device, a handset, or another terminal device.

The Locator is a routable location identifier, for example, it may be an IP address or another location identifier, which is used to indicate the location of the terminal.

In the embodiments of the present disclosure, for each user, the user ID, the device ID, and the Location ID (Locator for short) are mutually associated. A user may have one or multiple terminals, and a terminal may be allocated one or multiple Locators.

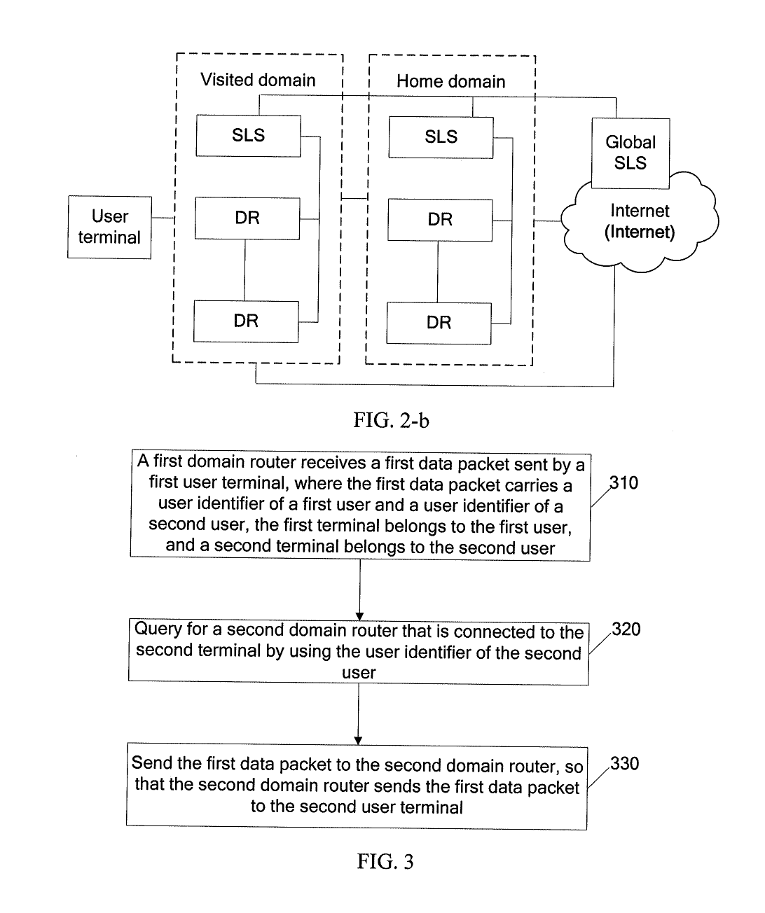

As shown in FIG. 2-a, it may be understood that a user ID may be associated with one or multiple device IDs and a device ID may be associated with one or multiple Locators. Thereby, a user ID may be associated with one or multiple Locators.

Referring to FIG. 2-b, an embodiment of the present disclosure further puts forward a network architecture for user-oriented communication.

Firstly, the global network may be divided into multiple domains (Domain) logically. Specifically, the domains may be divided according to the network topology information, operation strategy, or geological location information.

Further, a domain router (DR, Domain Router) and a subscriber location server (SLS, Subscriber Location Server) may be configured in each domain.

The SLS is configured to implement the functions of the control plane, and may associate and save the user identifier (User ID), device identifier (Device ID) of a terminal that belongs to the user, route information of the terminal (for example, it may includes home domain information and current domain information of the terminal, and location identifier of a DR that is connected to the terminal), and subscription information of the user.

The DR is configured to implement the functions of the user plane, for example, it may implement the function of forwarding data, and may save the user identifier and location identifier (user ID and location ID) of the terminal that is allocated to the user.

Based on different demands, an SLS and at least one DR may be configured in each domain. A communication interface may be configured between the SLS and the DR, and is used by the DR to query the SLS for route information of the user, and to update the user identifier information and route information. Definitely, each domain may also be only configured with a DR, and the functions implemented by the SLS are integrated into each DR. In the embodiment of the present disclosure, a situation that an SLS and at least one DR are configured at the same time in each domain is taken as an example.

Further, a communication interface may also be configured between SLSs in different domains with subscription relationships, and is used to query for route information between different domains. For example, according to the user ID, the SLS in the visited domain may query the SLS in the home domain for the location identifier of a DR that is connected to the user terminal.

Further, to facilitate the unified management on user identifiers in different networks of different operators, for example, a global SLS (global SLS) independent of each domain may be deployed by a third party network or on the Internet. A communication interface is configured between the global SLS and the SLS in each domain, so that the SLS in each domain may query the global SLS for home domain information or current domain information of the user through the communication interface.

Further, a local location identifier (local location ID, or local Locator for short) may be used to identify a location in each domain, so as to route data packets within a domain. It may be understood that, the local Locator is not required to be globally unique, but is only required to be unique in a domain.

Definitely, when network entities that belong to different domains communicate with each other, or when a network entity within a domain communicates with a network entity on the Internet, a global location identifier (global location ID, or global Locator for short) may be used to identify a location and to route data packets between different domains. It may be understood that, the global locator is required to be globally unique.

The location ID (Locator) is used to identify the location of each node device (including network elements such as a terminal and a DR) within the same domain. The DR has a local Locator and a global Locator at the same time. The local Locator of the terminal may be allocated by a corresponding DR or a gateway (GW, Gateway), and the local Locator of the terminal is used in intra-domain communication. When the terminal needs to communicate with a node outside the domain, a DR that is connected to the terminal may convert the network address between the local locator and the global Locator. However, the global locator used when the terminal communicates is a global Locator of the DR that is connected to the terminal.

The present disclosure does not limit the form of the Locator, and specific implementation modes are illustrated by only taking the IP address as an example. That is, in practical applications, the local Locator and the global Locator may be an IP address. The local Locator may be a private IP address, while the global Locator may be a public IP address.

The following further describes a user-oriented communication process in detail through specific embodiments.

### Embodiment 1

Referring to FIG. 3, a user-oriented communication method in Embodiment 1 may include the following:

Step 310: A first DR receives a first data packet sent by a first terminal, where the first data packet carries a user identifier of a first user and a user identifier of a second user, the first terminal belongs to the first user, and a second terminal belongs to the second user.

Step 320: Query for a second domain router that is connected to the second terminal according to the user identifier of the second user.

It may be understood that, at this time, the first terminal is a source terminal; the first user is a source user; the second terminal is a destination terminal; and the second user is a destination user. The first domain router is a domain router to which the first terminal is connected in a current domain of the first terminal. The second domain router is a domain router to which the second terminal is connected in a current domain of the second terminal.

In practical applications, for example, if the first domain router currently associates and saves the user identifier of the second user and a location identifier of the second domain router (that is, an association relationship between the user identifier of a user to which the second terminal belongs and the location identifier of the second domain router are acquired), the first domain router may query for the location identifier of the second domain router in the association information that is saved by the first domain router.

For example, if the first domain router does not currently associate and save the user identifier of the second user and the location identifier of the second domain router (that is, the association relationship between the user identifier of a user to which the second terminal belongs and the location identifier of the second domain router are not acquired), the first domain router may query a subscriber location server in a current domain for the location identifier of the second domain router, and the subscriber location server in the current domain may feed back the location identifier of the second domain router to the first domain router. In an application scenario, the first domain router may also query the subscriber location server in the current domain for other association information (for example, domain name information) of the second domain router, and according to the association information of the second domain router that is fed back by the subscriber location server in the current domain, query a device that is associated with the first domain router for the location identifier of the second domain router.

Step 330: Send the first data packet to the second domain router, so that the second domain router sends the first data packet to the second terminal.

In practical applications, the second domain router may associate and save the user ID of a user to which the second terminal belongs and the location ID (Locator) of the second terminal, that is, an association relationship between the user ID and the Locator of the terminal is saved.

After receiving the first data packet, the second domain router may query for a Locator of the second terminal according to the user ID of a user to which the second terminal belongs, where the user ID of the user is carried in the first data packet, and sends a first data packet to the second terminal according to the Locator.

It can be seen from the above solution that, in the embodiment of the present disclosure, based on a user identifier model, user-oriented communication is implemented in a network; because the user identifier is relatively stable, and transmission of a data packet is based on the user identifier, the communication is reliable and convenient, which helps to enhance the support for user mobility and reduce the implementation complexity of user mobility management.

Further, in the embodiment of the present disclosure, a conventional communication mode that is based on device identifier or address is abandoned, which facilitates the evolution and development of communication mode.

### Embodiment 2

To facilitate understanding, the following further describes a user-oriented communication method of the embodiment of the present disclosure in detail by taking a process of communication between a user A and a user B as an example.

This embodiment first provides two methods for implementing a protocol stack and two packet header formats of a data packet.

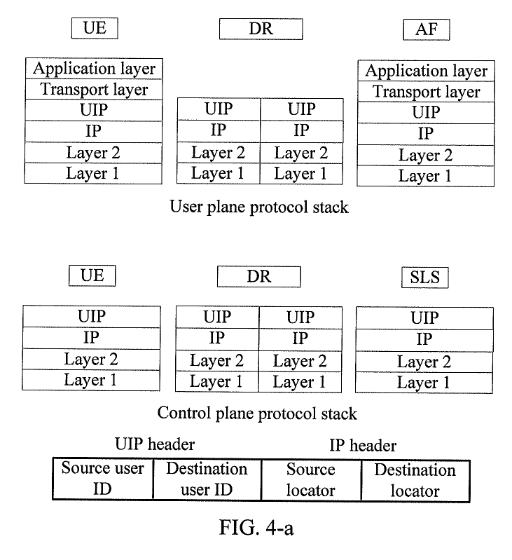

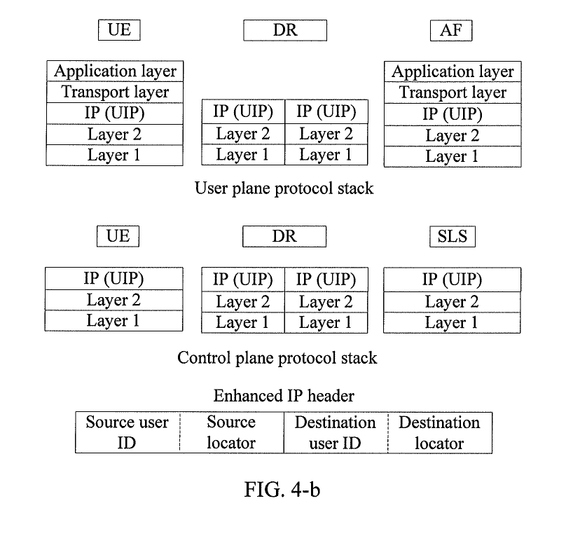

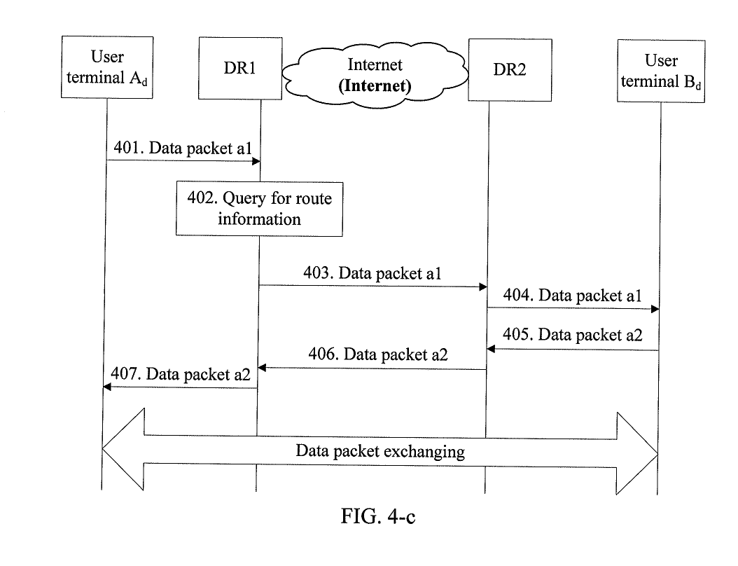

One protocol stack is shown in FIG. 4-a, that is, a user identifier protocol (UIP, User ID Protocol) layer is added between a network layer (that is, the IP layer) and a transport layer of the existing communication protocol stack.

The above existing communication protocol stack may be a protocol stack compliant with an open system interconnection (OSI, Open System Interconnection) 7-layer model, or be a Transmission Control Protocol/Internet Protocol (TCP/IP, Transmission Control Protocol/Internet Protocol) protocol stack, and the network layer is an IP layer. To facilitate description, the following embodiment illustrates a specific implementation mode of the present disclosure based on the TCP/IP protocol stack.

In this mode, the packet header format of a data packet that is exchanged between both communication parities may be as shown in FIG. 4-a. The packet header includes a UIP header and an IP header, where the UIP header includes a source user identifier field and a destination user identifier field, and the IP header includes a source address field and a destination address field.

The other protocol stack may be shown in FIG. 4-b, that is, the network layer (that is, the IP layer) of the existing communication protocol stack is modified, and the network layer is used to bear information of the UIP layer.

In this mode, the packet header format of the data packet that is exchanged between both communication parities may be shown in FIG. 4-b. The existing IP header is enhanced. The enhanced IP header includes a source user identifier field, a destination user identifier field, a source address field, and a destination address field.

For example, a terminal A_{d} belongs to a user A, and a terminal B_{d} belongs to a user B. Based on one of the above two protocol stack, the following introduces a process in which the terminal A_{d} of the user A and the terminal B_{d} of the user B exchange a data packet.

Referring to FIG. 4-c, a user-oriented communication method in Embodiment 2 of the present disclosure may include the following:

Step 401: The terminal A_{d} sends a data packet a1 to a DR1.

For example, the current user identifier of the user A is As, and the location identifier that is currently allocated to the terminal A_{d} is Aa (local location identifier); the current user identifier of the user B is Bs, and the location identifier that is currently allocated to the terminal B_{d} is Ba (local location identifier).

The packet header of the data packet sent between both communication parties includes: a source user identifier field, a destination user identifier field, a source address field, and a destination address field.

In an application scenario, the terminal A_{d} may carry the As (the source user identifier) in the source user identifier field of the packet header of the data packet a1, carry the Aa in the source address field thereof, and carry the Bs in the destination user identifier field. If the terminal A_{d} currently does not acquire the location identifier of a DR2 that is connected to the terminal B_{d}, the destination address field may be null or carry invalid information.

Particularly, the terminal A_{d} may not carry the Aa in the source address field in the packet header of the a1 data packet, but sets the source address field to be null or carries invalid information.

Step 402: According to the user identifier Bs of the user B carried in the destination user identifier field in the packet header of the data packet a1, the DR1 queries the DR2 that is currently connected to the terminal B_{d}.

In an application scenario, the DR1 may receive the data packet a1 sent by the terminal A_{d} according to the connection between the DR1 and the terminal A_{d}, and obtain the user identifier Bs (destination user identifier) of the user B by parsing the packet header of the data packet a1.

If the DR1 currently associates and saves the user identifier Bs of the user B and the location identifier of the DR2 (that is, the association relationship between the user identifier Bs and the location identifier of the DR2 is saved), the DR1 may query for the location identifier of the DR2 in the association information that is saved by the DR1 according to the user identifier Bs of the user B.

If the DR1 does not save the user ID Bs and the location identifier of the DR2, the DR1 may send a query request message to an SLS in the current domain of the user A, where the query request message carries the user identifier Bs of the user B, so as to query for the location identifier of the DR2 that is connected to the terminal B_{d}. The SLS in the current domain of the user A may also query, according to the user identifier Bs of the user B, for the location identifier of the DR2 in the association information that is associated and saved by the SLS, and feed back the queried location identifier of the DR2 to the DR1.

In practical applications, to make it convenient to manage and query for the association relationship between a user and a domain router, the SLS may maintain an association mapping table, where records of the association mapping table may include a field that is used to record the user identifier of a user and at least one of the following contents, such as a field recording the location identifier of a domain router that is currently connected to a terminal of the user, a field recording the device identifier of the terminal, a field recording the home domain information of the user, and a field recording the current domain information of the user.

For example, an association mapping table maintained by the SLS may be as shown in Table 1, but is not limited thereto:

TABLE 1

| User | Device | Home | Current | DR |
|---|---|---|---|---|
| Identifier | Identifier | Domain | Domain | Address |
| Bs | D_{b1} | Domain 001 | Domain 002 | Ba |
| Cs | D_{c1} | Domain 002 | Domain 002 | Ca |
| Ds | D_{d1} | Domain 003 | Domain 002 | Da |
| . . . | . . . | . . . | . . . | . . . |

In an application scenario, if the SLS in the current domain of the user A does not query for a record matching the user identifier Bs locally, the SLS may query the SLS in the home domain of the user B for the location identifier of the DR2 directly according to the user identifier Bs; or query the global SLS for the home domain information of the user B, and then query the SLS in the home domain of the user B for the location identifier of the DR2, and feed back the obtained location identifier of the DR2 to the DR1.

Particularly, if the user B is currently in a roaming state, that is, if the current domain of the user B and the home domain of the user B are different, and the SLS in the home domain of the user B does not query for a record matching the user identifier Bs locally, the SLS in the home domain of the user B may further query the SLS in the current domain of the user B for the location identifier of the DR2, and feed back the obtained location identifier of the DR2 to the DR1 stage by stage.

It should be noted that if the DR1 and the DR2 are located in a same domain, the location identifier of the DR2 obtained by the DR1 may be a local location identifier (local location ID, or local Locator for short). If the DR1 and the DR2 are located in different domains, the location identifier of the DR2 obtained by the DR1 may be a global location identifier (global location ID, or global Locator for short). This embodiment takes a situation that the DR1 and the DR2 are located in different domains as an example for illustration.

In another scenario, the DR1 may also query an SLS in the current domain for other association information (for example, domain name information) of the DR2, and according to the association information of the DR2 fed back by the SLS in the current domain, query a device associated with the DR1 for the location identifier of the DR2, and then perform subsequent processes.

Step 403: The DR1 sends a data packet a1 to the DR2 according to the location identifier of the DR2.

For example, if the global location identifier that is currently allocated to the DR1 is R1gs, the global location identifier that is currently allocated to the DR2 is R2gs.

In an application scenario, after the DR1 obtains the location identifier of the DR2, the DR1 replaces the source address (Aa) carried in the source address field in the packet header of the data packet a1 with the global location identifier Rigs of the DR1, and carries the global location identifier R2gs of the DR2 in the destination address field in the packet header of the data packet a1.

The DR1 sends a data packet a1 whose packet header is modified to the DR2. The DR1 performs the conversion from the local Locator to the global Locator.

Step 404: The DR2 sends a data packet a1 to the terminal B_{d}.

In an application scenario, after receiving the above data packet a1 whose packet header is modified sent by the DR1, the DR2 may further parse the packet header of the received data packet a1, and obtain the user identifier Bs of the user B carried in the packet header.

In practical applications, to facilitate management and query, the DR may maintain a route mapping table, where records of the route mapping table may include: a field used to record the user identifier of the user and a field used to record a local location identifier (local Locator) of a terminal that belongs to the user.

For example, a route mapping table maintained by the DR2 may be as shown in Table 2, but is not limited to thereto:

TABLE 2

| User | Local Location |
|---|---|
| Identifier | Identifier |
| Bs | Ba |
| Cs | Ca |
| Ds | Da |
| . . . | . . . |

The DR2 may query for the local location identifier Ba of the terminal B_{d} according to the user identifier Bs of the user B. The DR2 may replace the R2gs carried in the destination address field in the packet header of the data packet a1 with the local location identifier Ba of the terminal B_{d}, and send the data packet a1 whose packet header is modified to the terminal B_{d}.

It may be understood that, at this time, the source user identifier field in the packet header of the packet data a1 that the DR2 sends to the terminal B_{d} carries the user identifier As of the user A; the source address field carries the location information of the DR1; the destination user identifier field carries the user identifier Bs of the user B; and the destination address field carries the local location identifier Ba of the terminal B_{d}. The DR2 performs the conversion from the global Locator to the local Locator.

Particularly, the DR2 may also not modify the packet header of the data packet a1, but sends the packet header of the data packet a1 to the terminal B_{d} directly.

Step 405: The terminal B_{d} sends a data packet a2 to the DR2.

After receiving the data packet a1, the terminal B_{d} may obtain the global location identifier R1gs of the DR1 and the user identifier As of the user A by parsing the packet header of the data packet a1.

If necessary, the terminal B_{d} may send a data packet a2 to the DR2. The terminal A_{d} may carry the user identifier Bs of the user B in the source user identifier field in the packet header of the data packet a2, carry the local location identifier Ba of the terminal B_{d} in the source address field in the packet header of the data packet a2, carry the As in the destination user identifier field in the packet header of the data packet a2, and carry the global location identifier R1gs of the DR1 in the destination address field in the packet header of the data packet a2.

Step 406: The DR2 sends the data packet a2 to the DR1.

In an application scenario, the DR2 may replace the source address (Ba) carried in the source address field in the packet header of the data packet a2 with the global location identifier R2gs of the DR2, and send the data packet a2 whose packet header is modified to the DR2. The DR2 performs the conversion from the local Locator to the global Locator.

Step 407: The DR1 sends the data packet a2 to the terminal A_{d}.

In an application scenario, the DR1 may replace the global location identifier R1gs of the DR1 carried in the destination address field in the packet header of the data packet a2 with the local location identifier Aa of the terminal A_{d}, and send the data packet a2 whose packet header is modified to the terminal A_{d}.

The DR1 performs the conversion from the local Locator to the global Locator.

After receiving the data packet a2, the terminal A_{d} may obtain the global location identifier R2gs of the DR2 by parsing the packet header of the data packet a2. So far, both the communication parties (terminal A_{d} and terminal B_{d}) acquire the global location identifier of the peer DR. The terminal A_{d} and the terminal B_{d} may communicate directly through the DR1 and the DR2. The destination address field of the data packet exchanged between the terminal A_{d} and the terminal B_{d} may carry the global location identifier of the peer DR.

It should be noted that, this embodiment takes a situation that the terminal A_{d} and the terminal B_{d} are connected to different DRs as an example for illustration. If the terminal A_{d} and the terminal B_{d} are connected to a same DR, the DR may forward the data packet that is exchanged between the terminal A_{d} and the terminal B_{d}.

It can be seen from the above solution that, in this embodiment, based on a user identifier model, user-oriented communication is implemented on networks; because the user identifier is relatively stable, and transmission of a data packet is based on the user identifier, the communication is reliable and convenient, which helps to enhance the support for user mobility and reduce the implementation complexity of user mobility management.

Further, the communication process requires fewer MNs, and the air interface consumption is relatively low. In the communication process, the data processing load of the terminal is relatively low, which helps to reduce the software and hardware configurations of the terminal and reduce costs.

### Embodiment 3

This embodiment mainly illustrates a process of updating the route information of a DR and an SLS. A process in which a terminal A_{d} of a user A is connected to a DR1 through an access network (AN, Access Network) and performs route information registration is taken as an example for detailed description.

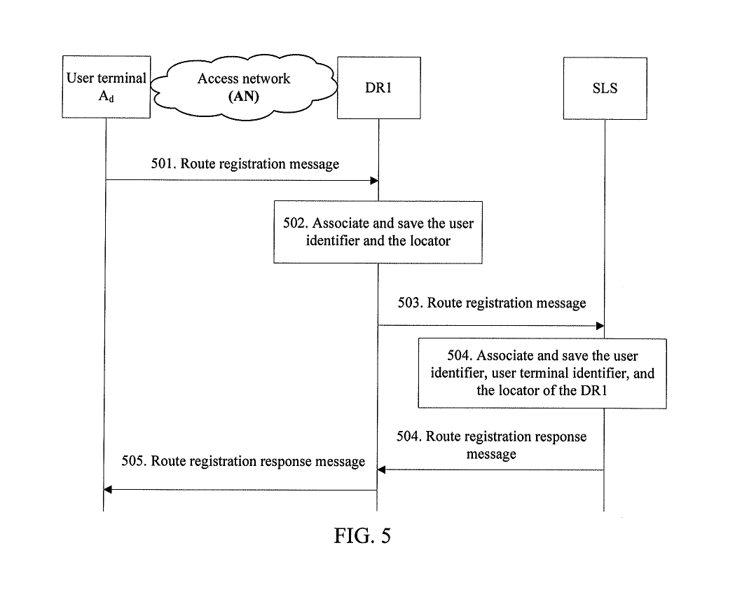

Referring to FIG. 5, a route registration method in Embodiment 3 of the present disclosure may include the following:

Step 501: The terminal A_{d} sends a route registration message to the DR1.

In an application scenario, the terminal A_{d} may initiate a process of route information registration when a preset route registration event occurs.

The above route registration event includes but is not limited to the following:

a. the terminal A_{d} accesses a network successfully, and sets up a connection with the DR1;

b. the terminal A_{d} moves from the coverage area of another DR to the coverage area of the DR1, that is, the DR connected to the terminal is changed; and

c. the terminal A_{d} creates a connection with a DR, and the DR of the new connection is the DR1.

For example, if the user identifier (User ID) of the user A is As, the device identifier (device ID) of the terminal A_{d} is A_{did}.

In practical applications, the above route registration message sent by the terminal A_{d} may carry the user identifier As of the user A and the device identifier A_{did} of the terminal A_{d}.

Optionally, the above route registration message may pass through a gateway on the access network or another gateway, and the gateway forwards the route registration message to the DR1.

Definitely, the terminal A_{d} may also report the user ID and the device ID to the DR1 according to other messages. For example, the terminal A_{d} may carry the user ID and the device ID in such messages as a DHCP (Dynamic Host Configuration Protocol, Dynamic Host Configuration Protocol) message, a MIP (Mobile Internet Protocol, mobile IP) registration message or a BU (Binding Update, binding update) message that are used to obtain an IP address.

Or, the DR1 may obtain the user ID and the device ID from other network elements. For example, in a network access authentication process of the terminal A_{d}, the DR1 obtains the user ID and the device ID from a home subscriber server (HSS, Home Subscriber Server) or an Authentication Authorization and Accounting (AAA, Authentication Authorization Accounting) server. It may be understood that, in a scenario where the user ID and the device ID are obtained from other network elements, step 501 may be omitted, and the DR1 may directly initiate a subsequent step of route registration.

Step 502: The DR1 associates and saves the user identifier As and the device identifier A_{did}, and allocates a local location identifier (local location ID, or local locator for short) to the terminal A_{d}.

Optionally, for example, after receiving a route registration message sent by the terminal A_{d}, the gateway allocates a local Locator to the terminal A_{d}, carries the allocated local Locator in the route registration message, and sends the route registration message to the DR1. The DR1 may directly associate and save the user identifier As, device identifier A_{did}, and the local Locator that the gateway allocates to the terminal A_{d}, which are carried in the route registration message.

Step 503: The DR1 sends a route registration message to an SLS in the current domain.

In an application scenario, the route registration message sent by the DR1 may carry the user identifier As, device identifier A_{did}, and global location identifier (global location ID, or global Locator for short) of the DR1. Definitely, the DR1 may also report the user ID, device ID, and the global Locator of the DR1 to the SLS in the current domain according to other messages.

Step 504: The SLS in the current domain associates and saves the user ID, device ID, and the global Locator of the DR1 that are reported by the DR1.

In practical applications, after the SLS in the current domain receives the route registration message sent by the DR1, it may parse the route registration message, and obtain such information as the user ID, device ID, and global Locator of the DR1 from the route registration message.

If the SLS maintains an association mapping table, it may use such information as the user ID, device ID, and the global Locator of the DR1 that are reported by the DR1 as a record, and add the record to the association mapping table maintained by the SLS to facilitate the management and query.

Optionally, the SLS in the current domain may send a route registration response message to the DR1.

Step 505: The DR1 sends a route registration response message to the terminal A_{d}, where the route registration response carries the local Locator that is allocated to the terminal A_{d}.

Optionally, the above route registration response message that is sent by the DR1 to the terminal A_{d} may be forwarded to the terminal A_{d} via the gateway.

The terminal A_{d} receives and parses the above route registration response message sent by the DR1, and obtains the local Locator that is allocated to the terminal A_{d}.

It should be noted that, if the user A is in a roaming state, that is, the current domain of the terminal A_{d} is a visited domain of the terminal A_{d}, at this time, the SLS in the current domain may further perform route information registration on the SLS in the home domain (Home Domain) of the terminal A_{d}.

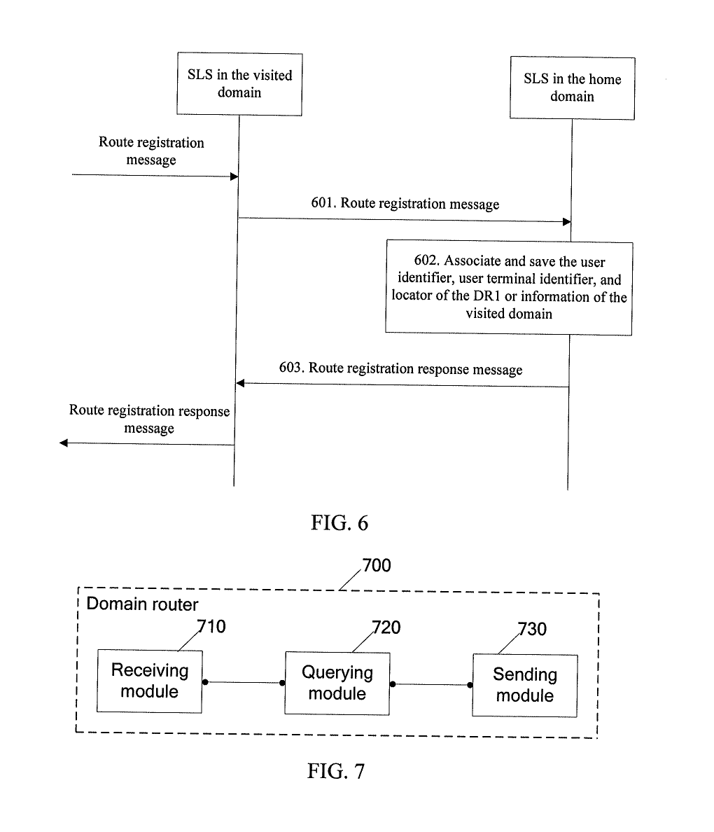

The process of performing route information registration on the SLS in the home domain by the SLS in the current domain is as shown in FIG. 6, and includes the following:

Step 601: The SLS in the current domain sends a route registration message to the SLS in the home domain.

The above route registration message may carry the user ID As, device ID A_{did}, and global Locator of the DR1, or the above route registration message may also carry the user ID As, device ID A_{did}, and domain information (for example, domain identifier information such as domain identifier and domain number) of the current domain (that is, the visited domain of the user A) of the DR1.

Step 602: The SLS in the home domain associates and saves the information that is carried in the above route registration message.

In practical applications, after the SLS in the home domain receives the route registration message sent by the SLS in the current domain, it may obtain the user ID, device ID, and global Locator of the DR1 that are carried in the route registration message, or obtain the user ID, device ID, and domain information of the visited domain that are carried in the route registration message by parsing the route registration message.

If the SLS in the home domain maintains an association mapping table, it may use the user ID, device ID, and global Locator of the DR1 that are reported by the SLS in the current domain or the user ID, device ID, and domain information of the visited domain that are reported by the SLS in the current domain as a record, and add the record to the association mapping table maintained by the SLS in the home domain to facilitate the management and query.

It may be understood that, the SLS in the home domain associates and saves the above information, which may be convenient for other devices to query for route information of the user A subsequently. If the SLS in the home domain associates and saves the user ID, device ID, and domain information of the visited domain of the user A, when another device queries the SLS in the home domain for the route information of the user A, the SLS in the home domain may first query the SLS in the visited domain for the location identifier of the DR1 according to the domain information of the visited domain of the user A, and then feed back to the corresponding device which requests to query for route information of the user A.

Step 603: Optionally, the SLS in the home domain sends a route registration response message to the SLS in the current domain.

So far, the process of initiating route information registration to the SLS in the home domain by the SLS in the visited domain ends.

It can be seen from the above that, in this embodiment, user route information is registered, and a domain router and a subscriber location server associate and save related route information of a user, which facilitates a smooth communication subsequently.

For better implementation of the solution of the embodiment of the present, an embodiment of the present disclosure further provides a domain router.

### Embodiment 4

Referring to FIG. 7, a domain router 700 in Embodiment 4 of the present disclosure may include a receiving module 710, a querying module 720, and a sending module 730.

The receiving module 710 is configured to receive a first data packet sent by a first terminal, where the first data packet carries a user identifier of a first user and a user identifier of a second user, the first terminal belongs to the first user, and a second terminal belongs to the second user.

The querying module 720 is configured to query for a second domain router that is connected to the second terminal according to the user identifier of the second user.

The sending module 730 is configured to send the first data packet to the second domain router, so that the second domain router sends the first data packet to the second terminal.

The above user identifiers may be located at a new user identifier protocol layer between the network layer and the transport layer or be located at the modified network layer.

In an application scenario, if the domain router 700 currently associates and saves the user identifier of a user to which the second terminal belongs and the location identifier of the second domain router (that is, an association relationship between the user identifier of the user to which the second terminal belongs and the location identifier of the second domain router is acquired), the querying module 720 may query for the location identifier of the second domain router in the information that is associated and saved by the domain router 700.

In an application scenario, the querying module 720 may include: a first sending submodule and a receiving and obtaining submodule.

The first sending submodule is configured to send a message that carries the user identifier of the second user to a subscriber location server in the current domain, and request to query for a location identifier of the second domain router that is connected to the second terminal.

The receiving and obtaining submodule is configured to: receive a message that carries the location identifier of the second domain router sent by the subscriber location server in the current domain, and obtain the location identifier of the second domain router.

After the subscriber location server in the current domain receives the message that carries the user identifier of the second user, it may parse the message, obtain the user identifier of the second user; query for the location identifier of the second domain router that is connected to the second terminal according to the user identifier of the second user, and feed back the location identifier of the second domain router to the domain router 700.

In an application scenario, the packet header of the first data packet received by the receiving module 710 includes: a source user identifier field, a destination user identifier field, a source address field, and a destination address field. The above source user identifier field carries the user identifier of the first user, and the above destination user identifier field carries the user identifier of the second user.

The sending module 730 may include: a packet header modifying submodule and a second sending submodule.

The packet header modifying submodule is configured to: carry the location identifier of the first domain router in the source address field in the packet header of the first data packet, carry the location identifier of the second domain router in the destination address field in the packet header of the first data packet, and obtain a first data packet whose packet header is modified.

The second sending submodule is configured to send the first data packet whose packet header is modified by the packet header modifying submodule to the second domain router.

In practical applications, the second domain router may associate and save the user ID of the second user and the location ID (Locator for short) of the second terminal, that is, an association relationship between the user ID and the Locator of the terminal is saved.

After receiving the first data packet, the second domain router may query for a Locator corresponding to the second terminal according to the user ID of a user to which the second terminal belongs, where the user identifier of the user is carried in the first data packet, and send the first data packet to the second terminal according to the Locator.

It may be understood that, the domain router 700 in this embodiment may be like the domain router in the foregoing method embodiments. The functions of each functional module of the domain router 700 may be specifically implemented according to the method in the foregoing method embodiments. For a specific implementation process, reference may be made to related descriptions in the foregoing embodiments, and is not further described here.

For better implementation of the solution of the embodiment of the present disclosure, an embodiment of the present disclosure further provides a domain router.

### Embodiment 5

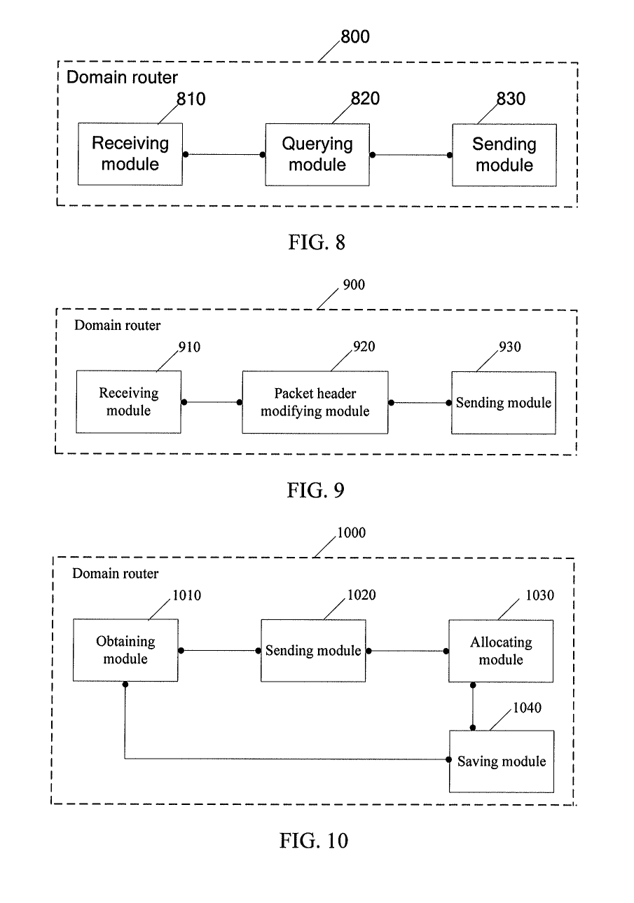

Referring to FIG. 8, a domain router 800 in Embodiment 5 of the present disclosure may include a receiving module 810, a querying module 820, and a sending module 830.

The receiving module 810 is configured to receive a first data packet, where the first data packet carries a user identifier of a first user and a user identifier of a second user, and a second terminal belongs to the second user.

The querying module 820 is configured to query for a local location identifier of the second terminal according to the user identifier of the second user.

The sending module 830 is configured to send the first data packet to the second terminal according to the local location identifier of the second terminal queried by the querying module 820.

The above user identifiers may be located at a new user identifier protocol layer between the network layer and the transport layer or be located at the modified network layer.

It may be understood that, the domain router 800 in this embodiment may be like the domain router in the foregoing method embodiments. The functions of each functional module of the domain router 800 may be specifically implemented according to the method in the foregoing method embodiments. For a specific implementation process, reference may be made to related descriptions in the foregoing embodiments, and is not further described here.

For better implementation of the solution of the embodiment of the present disclosure, an embodiment of the present disclosure further provides a domain router.

### Embodiment 6

Referring to FIG. 9, a domain router 900 in Embodiment 6 of the present disclosure may include a receiving module 910, a packet header modifying module 920, and a sending module 930.

The receiving module 910 is configured to receive a first data packet that is sent by a second terminal, where the packet header of the first data packet carries a user identifier of a first user, a user identifier of a second user, and a location identifier of the first domain router that is connected to the first terminal; the first terminal belongs to the first user; and a second terminal belongs to the second user.

The packet header modifying module 920 is configured to modify the packet header of the first data packet, where the modified packet header of the first data packet carries the user identifier of the first user, the user identifier of the second user, the location identifier of the first domain router that is connected to the first terminal, and the location identifier of the second domain router.

The sending module 930 is configured to send the first data packet whose packet header is modified by the packet header modifying module 920 to the first domain router.

The above user identifiers may be located at a new user identifier protocol layer between the network layer and the transport layer or be located at the modified network layer.

In practical applications, the first domain router may associate and save the user ID of the first user and the location ID (Locator for short) of the first terminal, that is, an association relationship between the user ID and the Locator of the terminal is saved.

After receiving the first data packet, the first domain router may query for the Locator of the first terminal according to the user ID of the first user that is carried in the first data packet, and send the first data packet to the second terminal according to the Locator.

It may be understood that, the domain router 900 in this embodiment may be like the domain router in the foregoing method embodiments. The functions of each functional module of the DR 900 may be implemented according to the method in the foregoing method embodiments. For a specific implementation process, reference may be made to related descriptions in the foregoing embodiments, and is not further described here.

For better implementation of the solution of the embodiment of the present disclosure, an embodiment of the present disclosure further provides a domain router.

### Embodiment 7

Referring to FIG. 10, a domain router 1000 in Embodiment 7 of the present disclosure may include: a obtaining module 1010, an allocating module 1030, and a sending module 1020.

The obtaining module 1010 is configured to obtain a device identifier of a first terminal and a user identifier of a first user, where the first terminal belongs to the first user.

In an application scenario, the obtaining module 1010 may obtain the device identifier of the first terminal and the user identifier of the first user according to various modes, for example, it may receive a message that carries the device identifier of the first terminal and the user identifier of the first user, and obtain the device identifier of the first terminal and the user identifier of the first user from the message.

The sending module 1020 is configured to send a route registration message to a subscriber location server in a current domain, where the route registration message carries the device identifier of the first terminal, user identifier of the first user, and association information of the first domain router.

In an application scenario, the domain router 1000 may further include:

an allocating module 1030, configured to allocate a local location identifier to the first terminal; and

a second sending module, configured to: send a message that carries the local location identifier that the allocating module 1030 allocates to the first terminal to the first terminal, and notify the first terminal of the local location identifier of the first terminal.

In an application scenario, the domain router 1000 may further include:

a saving module 1040, configured to associate and save the local location identifier of the first terminal and the user identifier of the first user (that is, save an association relationship between the local location identifier of the first terminal and the user identifier of the first user).

In an application scenario, a gateway or another device in a network may allocate a local location identifier to the first terminal, and notify the domain router 1000 of the local location identifier that is allocated to the first terminal.

The saving module 1040 may directly associate and save the user identifier of the first user and the local location identifier that the gateway or another device in the network allocates to the first terminal.

It may be understood that, the domain router 1000 in this embodiment may be like the domain router in the foregoing method embodiments. The functions of each functional module of the domain router 1000 may be specifically implemented according to the method in the foregoing method embodiments. For a specific implementation process, reference may be made to related descriptions in the foregoing embodiments, and is not further described here.

For better implementation of the solution of the embodiment of the present disclosure, an embodiment of the present disclosure further provides a domain router.

### Embodiment 8

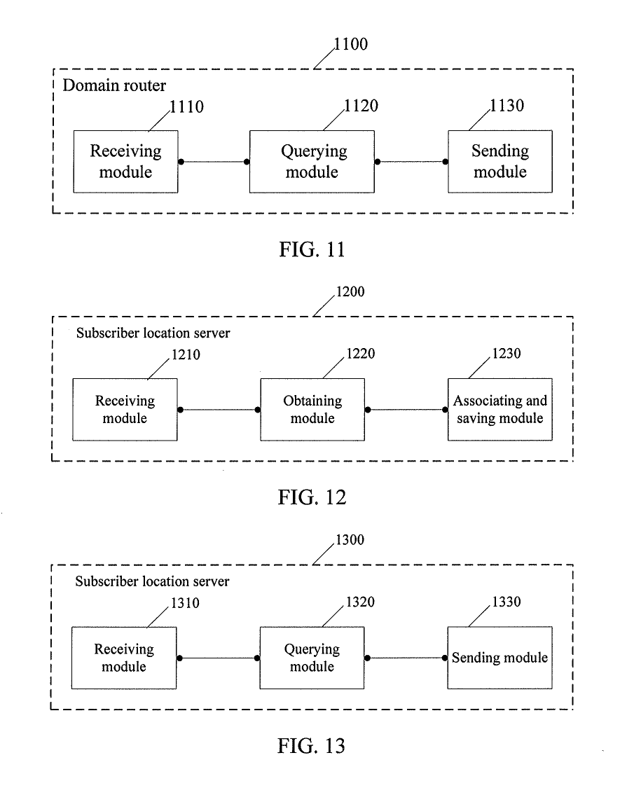

Referring to FIG. 11, a domain router 1100 in Embodiment 8 of the present disclosure may include: a receiving module 1110, a querying module 1120, and a sending module 1130.

The receiving module 1110 is configured to receive a first data packet sent by a first terminal, where the first data packet carries a user identifier of a first user and a user identifier of a second user, the first terminal belongs to the first user, and a second terminal belongs to the second user.

The first terminal and the second terminal are connected to the domain router 1100.

The querying module 1120 is configured to query for the local location identifier of the second terminal according to the user identifier of the second user.

The sending module 1130 is configured to send the first data packet to the second terminal according to the local location identifier of the second terminal.

The above user identifiers may be located at a new user identifier protocol layer between the network layer and the transport layer or be located at the modified network layer.

It may be understood that, the domain router 1100 in this embodiment may be like the domain router in the foregoing method embodiments. The functions of each functional module of the domain router 1100 may be specifically implemented according to the method in the foregoing method embodiments. For a specific implementation process, reference may be made to related descriptions in the foregoing embodiments, and is not further described here.

For better implementation of the solution of the embodiment of the present disclosure, an embodiment of the present disclosure further provides a subscriber location server.

### Embodiment 9

Referring to FIG. 12, a subscriber location server in Embodiment 9 of the present disclosure may include: a receiving module 1210, an obtaining module 1220, and an associating and saving module 1230.

The receiving module 1210 is configured to receive a first route registration message, where the first route registration message carries a device identifier of a first terminal, a user identifier of a first user, and association information of a first domain router, and the first terminal belongs to the first user.

In an application scenario, the above association information of the first domain router may be: a location identifier of the first domain router, a domain name of the first domain router or other information that can be associated with the first domain router.

The obtaining module 1220 is configured to obtain the device identifier of the first terminal, the user identifier of the first user, and the location identifier of the first domain router from the first route registration message that is received from the receiving module 1210.

The associating and saving module 1230 is configured to associate and save the device identifier of the first terminal, the user identifier of the first user, and the association information of the first domain router that are obtained by the obtaining module 1220.

It may be understood that, the subscriber location server 1200 in this embodiment may be like the subscriber location server in the foregoing method embodiments. The functions of each functional module of the subscriber location server 1200 may be specifically implemented according to the method in the foregoing method embodiments. For a specific implementation process, reference may be made to related descriptions in the foregoing embodiments, and is not further described here.

For better implementation of the solution of the embodiment of the present disclosure, an embodiment of the present disclosure further provides a subscriber location server.

### Embodiment 10

Referring to FIG. 13, a subscriber location server 1300 in Embodiment 10 of the present disclosure may include: a receiving module 1310, a querying module 1320, and a sending module 1330.

The receiving module 1310 is configured to receive a query request message sent by a first domain router, where the query request message carries a user identifier of a user to which a second terminal belongs.

The querying module 1320 is configured to query for a location identifier of a second domain router that is connected to the second terminal according to the user identifier of the user to which the second terminal belongs.

The sending module 1330 is configured to send a query response message to the first domain router, where the query response message carries the location identifier of the second domain router, so that the first domain router sends a data packet to the second domain router according to the location identifier of the second domain router.

It may be understood that, the subscriber location server 1300 in this embodiment may be like the subscriber location server in the foregoing method embodiments. The functions of each functional module of the subscriber location server 1300 may be specifically implemented according to the method in the foregoing method embodiments. For a specific implementation process, reference may be made to related descriptions in the foregoing embodiments, and is not further described here.

For better implementation of the solution of the embodiment of the present disclosure, an embodiment of the present disclosure further provides a communication system.

### Embodiment 11

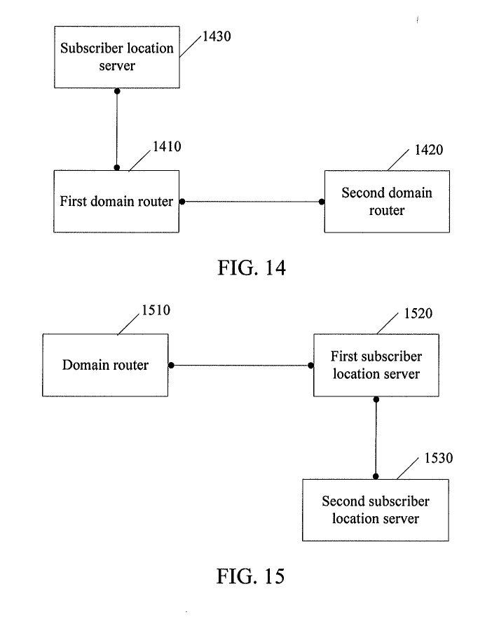

Referring to FIG. 14, a communication system in Embodiment 11 of the present disclosure may include: a first domain router 1410 and a second domain router 1420.

The first domain router 1410 is configured to: receive a first data packet sent by a first terminal, where the first data packet carries a user identifier of a first user and a user identifier of a second user, the first terminal belongs to the first user, and a second terminal belongs to the second user; query for the second domain router 1420 that is connected to the second terminal according to the user identifier of the second user; and send the first data packet to the second domain router 1420.

The second domain router 1420 is configured to: receive the first data packet sent by the first domain router 1410, where the first data packet carries the user identifier of the first user and the user identifier of the second user; query for a local location identifier of the second terminal according to the user identifier of the second user; and send the first data packet to the second terminal according to the local location identifier of the second terminal.

The above user identifiers may be located at a new user identifier protocol layer between the network layer and the transport layer or be located at the modified network layer.

In an application scenario, the above communication system may further include a subscriber location server 1430. The first domain router 1410 may send a query request message to the subscriber location server 1430, requesting to query for the location identifier of the second domain router that is connected to the second terminal.

The subscriber location server 1430 is configured to: receive the query request message sent by the first domain router, where the query request message carries the user identifier of the second user; query for the location identifier of the second domain router according to the user identifier of the second user; and send a query response message to the first domain router, where the query response message carries the location identifier of the second domain router.

It may be understood that, the functions of each entity of the communication system in this embodiment may be specifically implemented according to the method in the foregoing method embodiments. For a specific implementation process, reference may be made to related descriptions of the foregoing embodiments, and is not further described here.

For better implementation of the solution of the embodiment of the present disclosure, an embodiment of the present disclosure further provides a communication system.

### Embodiment 12

Referring to FIG. 15, a communication system in Embodiment 12 of the present disclosure may include: a domain router 1510 and a first subscriber location server 1520.

The domain router 1510 is configured to obtain a device identifier of a first terminal and a user identifier of a first user, where the first terminal belongs to the first user; send a first route registration message to the first subscriber location server 1520, where the first route registration message carries the device identifier of the first terminal, the user identifier of the first user, and a location identifier of the domain router 1510 (and/or other association information of the domain router 1510).

The first subscriber location server 1520 is configured to: receive the first route registration message; parse the first route registration message, and obtain the device identifier of the first terminal, the user identifier of the first user, and the location identifier of the domain router 1510; associate and save the device identifier of the first terminal, the user identifier of the first user, and the location identifier of the domain router 1510 (and/or other association information of the domain router 1510).

In an application scenario, the domain router 1510 is further configured to: allocate a local location identifier to the first terminal, and notify the first terminal of the local location identifier that is allocated to the first terminal.

In an application scenario, the domain router 1510 may be further configured to associate and save the local location identifier of the first terminal and the user identifier of the first user (that is, save an association relationship between the local location identifier of the first terminal and the user identifier of the first user).

In an application scenario, a gateway or another device in a network may allocate a local location identifier to the first terminal, and notify the domain router 1510 of the local location identifier that is allocated to the first terminal. The domain router 1510 may directly associate and save the user identifier of the first user and the notified local location identifier of the first terminal.

In an application scenario, if the first terminal (the first user) is in a roaming state, and the current domain of the first terminal is a visited domain of the first terminal, at this time, the first subscriber location server 1520 is a subscriber location server in the visited domain of the first terminal.

The communication system may further include a second subscriber location server 1530, where the second subscriber location server 1530 is the subscriber location server in the home domain of the first terminal (the first user).

At this time, the first subscriber location server 1520 may be further configured to: send a second route registration message to the second subscriber location server 1530, where the second route registration carries the device identifier of the first terminal, the user identifier of the first user, and the location identifier of the first domain router; and/or may be further configured to send a third route registration message to the second subscriber location server 1530, where the third route registration message carries the device identifier of the first terminal, the user identifier of the first user, and domain information of the current domain of the first terminal.

The second subscriber location server 1530 is configured to: receive the second route registration message sent by the first subscriber location server 1520, and obtain the device identifier of the first terminal, the user identifier of the first user, and the location identifier of the first domain router from the second route registration message; associate and save the device identifier of the first terminal, the user identifier of the first user, and the location identifier of the first domain router (that is, save the association relationship between the device identifier of the first terminal, the user identifier of the first user, and the location identifier of the first domain router); and/or receive the third route registration message sent by the first subscriber location server 1520, and obtain the device identifier of the first terminal, the user identifier of the first user, and domain information of the current domain of the first terminal; and associate and save the obtained device identifier of the first terminal, the user identifier of the first user, and domain information of the current domain of the first terminal (that is, save the association relationship between the device identifier of the first terminal, the user identifier of the first user, and domain information of the current domain of the first terminal).

It may be understood that, the functions of each entity of the communication system in this embodiment may be specifically implemented according to the method in the foregoing method embodiments. For a specific implementation process, reference may be made to related descriptions of the foregoing embodiments, and is not further described here.

An embodiment of the present disclosure further provides a user-oriented communication method, including:

receiving, by a second domain router, a first data packet, where the first data packet carries a user identifier of a first user and a user identifier of a second user, and a second terminal belongs to the second user;

querying for a local location identifier of the second terminal according to the user identifier of the second user; and

sending the first data packet to the second terminal according to the local location identifier of the second terminal.

In an application scenario, the above identifier is located at the user identifier layer of the protocol stack, or the above user identifier is located at the network layer.

An embodiment of the present disclosure further provides a user-oriented communication method, including:

receiving, by a second domain router, a first data packet sent from a second terminal, where the packet header of the first data packet carries a user identifier of a first user, a user identifier of a second user, and a location identifier of a first domain router that is connected to a first terminal, the first terminal belongs to the first user, and the second terminal belongs to the second user;

modifying the packet header of the first data packet, where the modified packet header of the first data packet carries the user identifier of the first user, the user identifier of the second user, the location identifier of the first domain router that is connected to the first terminal, and the location identifier of the second domain router; and

sending the first data packet whose packet header is modified to the first domain router.

An embodiment of the present disclosure further provides a route registration method, including:

obtaining, by a first domain router, a device identifier of a first terminal and a user identifier of a first user, where the first terminal belongs to the first user; and

sending a route registration message to a subscriber location server in a current domain, where the route registration message carries the device identifier of the first terminal, user identifier of the first user, and association information of the first domain router.

The above association information of the first domain router may be various information that can be associated with the first domain router, for example, a domain name of the first domain router, a location identifier of the first domain router, and other association information of the first domain router.

In an application scenario, the first domain router may further:

allocate a local location identifier to the first terminal; and

save the local location identifier of the first terminal and the user identifier of the first user.

An embodiment of the present disclosure further provides a route registration method, including:

receiving, by a first subscriber location server, a first route registration message, where the first route registration message carries a device identifier of a first terminal, a user identifier of a first user, and association information of a first domain router, and the first terminal belongs to the first user;

obtaining the device identifier of the first terminal, the user identifier of the first user, and a location identifier of the first domain router from the first route registration message; and

saving the obtained device identifier of the first terminal, user identifier of the first user, and association information of the first domain router.

The above association information of the first domain router may be various information that can be associated with the first domain router, for example, a domain name of the first domain router, a location identifier of the first router, and other association information of the first domain router.

In an application scenario, if the first subscriber location server is a subscriber location server in a visited domain of the first terminal, the first subscriber location server may further:

send a second route registration message to a second subscriber location server, where the second route registration message carries the device identifier of the first terminal, the user identifier of the first user, and the location identifier of the first domain router;

or

send a third route registration message to a second subscriber location server, where the third route registration message carries the device identifier of the first terminal, the user identifier of the first user, and domain information of the current domain of the first terminal, and the second subscriber location server is a subscriber location server in a home domain of the first terminal.

It should be noted that, for simple description of the foregoing method embodiments, the method embodiments are described as a combination of a series of actions. However, it should be known by those skilled in the art that, the present disclosure is not limited by the sequence of the actions. Some steps may be performed in other sequences or at the same time according to the present disclosure. In addition, it should be known by those skilled in the art that, the embodiments in the specification are all exemplary embodiments and actions and modules involved are not mandatory for the present disclosure.

In the foregoing embodiments, each embodiment has emphasis. For a part that is not described in detail in a certain embodiment, reference may be made to the related description of another embodiment.

To sum up, in embodiments of the present disclosure, based on a user identifier model, user-oriented communication is implemented in a network; because the user identifier is relatively stable, and the transmission of a data packet is based on the user identifier, the communication is reliable and convenient, which helps to enhance the support for user mobility and reduce the implementation complexity of user mobility management.

Further, the communication process requires fewer MNs, and the air interface consumption is relatively low; and the data processing load of the terminal is relatively low in the communication process, which facilitates the reduction in the software and hardware configurations of the terminal and costs. In embodiments of the present disclosure, a conventional communication mode that is based on device identifier or IP address is abandoned, which facilitates the evolution and development of the communication mode.

It may be understood by persons of ordinary skill in the art that, all or part of steps of the methods in embodiments of the present disclosure may be completed by a program instructing related hardware. The program may be stored in a computer readable storage medium. The storage medium may include: a read-only memory (ROM, Read-Only Memory), a random access memory (RAM, Random Access Memory), a magnetic disk, or an optical disk.

A user-oriented communication method, a route registration method and device, and a communication system provided in embodiments of the present disclosure have been described in detail above. The principle and implementation of the present disclosure are described here through specific embodiments. The above descriptions of the embodiments are merely provided for better understanding of the method and core ideas of the present disclosure. At the same time, persons of ordinary skill in the art may make modifications to the specific implementation and application scope in terms of the ideas of the present disclosure. To sum up, the specification shall not be construed as limitations to the present disclosure.

What is claimed is:

1. A user-oriented communication method, comprising:
receiving, by a first domain router, a first data packet sent by a first terminal, wherein the first data packet comprises a user identifier of a first user and a user identifier of a second user, the first terminal belongs to the first user, and a second terminal belongs to the second user;
querying for a second domain router that is connected to the second terminal according to the user identifier of the second user; and
sending the first data packet to the second domain router so that the second domain router sends the first data packet to the second terminal.

2. The method according to claim 1, wherein the user identifier is located at one of the following: a user identifier layer of a protocol stack, and a network layer.

3. The method according to claim 1, wherein:
a packet header of the first data packet comprises: a source user identifier field and a destination user identifier field, a source address field, and a destination address field, wherein the source user identifier field comprises the user identifier of the first user, and the destination user identifier field comprises the user identifier of the second user.

4. The method according to claim 1, wherein querying for the second domain router connected to the second terminal according to the user identifier of the second user comprises:
sending a message that comprises the user identifier of the second user to a subscriber location server in a current domain, requesting to query for a location identifier of the second domain router that is connected to the second terminal; and
receiving a message that comprises the location identifier of the second domain router from the subscriber location server in the current domain, and obtaining the location identifier of the second domain router.

5. The method according to claim 3, wherein the sending the first data packet to the second domain router comprises:
carrying a location identifier of a first domain router in the source address field of the packet header of the first data packet, and carrying a location identifier of the second domain router in the destination address field, and obtaining the first data packet having a modified packet header; and
sending the first data packet having the modified packet header to the second domain router.

6. A route registration method, comprising:
obtaining, by a first domain router, a device identifier of a first terminal and a user identifier of a first user, wherein the first terminal belongs to the first user; and
sending a route registration message to a subscriber location server in a current domain, wherein the route registration message comprises the device identifier of the first terminal, the user identifier of the first user, and association information of the first domain router.

7. The method according to claim 6, further comprising:
allocating a local location identifier to the first terminal; and
saving the local location identifier of the first terminal and the user identifier of the first user.

8. A route registration method, comprising:
receiving, by a first subscriber location server, a first route registration message, wherein the first route registration message comprises a device identifier of a first terminal, a user identifier of a first user, and association information of a first domain router, and the first terminal belongs to the first user;
obtaining the device identifier of the first terminal, the user identifier of the first user, and a location identifier of the first domain router from the first route registration message; and
saving the obtained device identifier of the first terminal, user identifier of the first user, and association information of the first domain router.

9. The method according to claim 8, wherein if the first subscriber location server is a subscriber location server in a visited domain of the first terminal, the method further comprises at least one of:
sending a second route registration message to a second subscriber location server, wherein the second route registration message comprises the device identifier of the first terminal, the user identifier of the first user, and the location identifier of the first domain router;
and
sending a third route registration message to the second subscriber location server, wherein the third route registration message comprises the device identifier of the first terminal, the user identifier of the first user, and domain information of a current domain of the first terminal, and the second subscriber location server is a subscriber location server in a home domain of the first terminal.

10. A domain router, comprising:
a receiving module, configured to receive a first data packet sent by a first terminal, wherein the first data packet comprises a user identifier of a first user and a user identifier of a second user, the first terminal belongs to the first user, and a second terminal belongs to the second user;
a querying module, configured to query for a second domain router connected to the second terminal according to the user identifier of the second user; and
a sending module, configured to send the first data packet to the second domain router, so that the second domain router sends the first data packet to the second terminal.

11. The domain router according to claim 10, wherein:
the querying module comprises:
a first sending submodule, configured to: send a message that comprises the user identifier of the second user to a subscriber location server in a current domain, and request to query for a location identifier of the second domain router that is connected to the second terminal; and
a receiving and obtaining submodule, configured to receive a message that comprises the location identifier of the second domain router from the subscriber location server in the current domain, and obtain the location identifier of the second domain router.

12. The domain router according to claim 10, wherein:
a packet header of the first data packet received by the receiving module comprises: a source user identifier field and a destination user identifier field, a source address field, and a destination address field, wherein the source user identifier field comprises the user identifier of the first user and the destination user identifier field carries the user identifier of the second user.

13. The domain router according to claim 12, wherein:
the sending module comprises:
a packet header modifying submodule, configured to: carry a location identifier of a first domain router in the source address field of the packet header of the first data packet, carry the location identifier of the second domain router in the destination address field, and obtain the first data packet having a modified packet header; and
a second sending submodule, configured to send the first data packet having the modified packet header to the second domain router.

14. A domain router, comprising:
an obtaining module, configured to obtain a device identifier of a first terminal and a user identifier of a first user, wherein the first terminal belongs to the first user; and
a sending module, configured to send a route registration message to a subscriber location server in a current domain, wherein the route registration message comprises a device identifier of the first terminal, the user identifier of the first user, and association information of a first domain router.

15. A subscriber location server, comprising:
a receiving module, configured to receive a first route registration message, wherein the first route registration message comprises a device identifier of a first terminal, a user identifier of a first user, and association information of a first domain router, and the first terminal belongs to the first user;
an obtaining module, configured to obtain the device identifier of the first terminal, the user identifier of the first user, and a location identifier of the first domain router from the first route registration message that is received by the receiving module; and
an associating and saving module, configured to save the device identifier of the first terminal, user identifier of the first user, and association information of the first domain router that are obtained by the obtaining module.

16. A communication system, comprising:
a first domain router, configured to: receive a first data packet sent by a first terminal, wherein the first data packet comprises a user identifier of a first user and a user identifier of a second user, the first terminal belongs to the first user, and a second terminal belongs to the second user; query for a second domain router that is connected to the second terminal according to the user identifier of the second user, and send the first data packet to the second domain router; and
the second domain router, configured to receive the first data packet sent by the first domain router, wherein the first data packet comprises the user identifier of the first user and the user identifier of the second user; query for a local location identifier of the second terminal according to the user identifier of the second user; and send the first data packet to the second terminal according to the local location identifier of the second terminal.
